(19) United States
(12) Patent Application Publication
(10) Pub. No.: US 2009/0159562 A1
(43) Pub. Date: Jun. 25, 2009

(54) METHOD FOR FABRICATING MAGNETIC TUNNEL JUNCTION DEVICE

(75) Inventors: Sang-Hoon CHO, Ichon-shi (KR); Yun-Seok CHO, Ichon-shi (KR); Jung-Hee PARK, Ichon-shi (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HYNIX SEMICONDUCTOR INC., Ichon-shi (KR)

(21) Appl. No.: 12/165,352

(22) Filed: Jun. 30, 2008

(30) Foreign Application Priority Data
Dec. 21, 2007 (KR) 10-2007-0135013

(51) Int. Cl. B44C 1/22

(52) U.S. Cl. 216/22

(57) ABSTRACT

A method for fabricating a magnetic tunnel junction device includes forming a first magnetic layer, a dielectric layer, a second magnetic layer and a capping layer, selectively etching the capping layer and the second magnetic layer to form a first pattern, forming a short prevention layer on a sidewall of the first pattern, and etching the dielectric layer and the first magnetic layer using the capping layer and the short prevention layer as an etch barrier to form a second pattern.

### CROSS-REFERENCE TO RELATED APPLICATIONS

The present invention claims priority of Korean patent application number 2007-0135013, filed on Dec. 21, 2007, which is incorporated by reference in its entirety.

### BACKGROUND OF THE INVENTION

The present invention relates to a method for manufacturing a semiconductor device, and more particularly, to a method for fabricating a magnetic tunnel junction (MTJ) device.

Recently, as semiconductor devices become highly integrated, a magnetic random access memory (MRAM) has attracted a good deal of attention as a next generation non-volatile semiconductor memory device of high performance. The MRAM includes a transistor performing a switching operation, and an MT device for storing data.

The electric resistance of the MT device is changed according to the magnetization direction of ferromagnetic layers separated by a dielectric layer. Using voltage change or current change according to the resistance change, it can be determined which logic level of “1” or “0⇄ the data stored in the MTJ device has.

FIG. 1 illustrates a cross-sectional view of a typical MTJ device on which an etch byproduct is deposited. FIG. 2 illustrates a scanning electron micrograph of a typical MTJ device on which an etch byproduct is deposited.

Referring to FIGS. 1 and 2, an anti-ferromagnetic layer 11, a first ferromagnetic layer 12, a dielectric layer 13 and a second ferromagnetic layer 14 are sequentially formed, and then a hard mask pattern 15 is formed over the second ferromagnetic layer 14.

The second ferromagnetic layer 14, the dielectric layer 13, the first ferromagnetic layer 12 and the anti-ferromagnetic layer 11 are sequentially etched using the hard mask pattern 15 as an etch barrier to form a magnetic tunnel junction device.

The anti-ferromagnetic layer 11, the first ferromagnetic layer 12 and the second ferromagnetic layer 14 are formed of metal compounds. Accordingly, etching for fabricating the MTJ device may produce a conductive etch byproduct 16, and thus may deteriorate electrical properties of the MTJ device. In more detail, the first and second ferromagnetic layers 12 and 14 are required to be separated from each other by the dielectric layer 13 so that the MTJ device can operate normally. However, the conductive etch byproduct 16 redeposited on a sidewall of the MTJ device may short the first and second ferromagnetic layers 12 and 14. Further, this may cause a fail in a semiconductor device, such as an MRAM, utilizing the MTJ device, and thereby reduce reliability and manufacturing yield of the semiconductor device.

### SUMMARY OF THE INVENTION

Embodiments of the present invention are directed to providing a method for fabricating an MTJ device, capable of preventing deterioration of electric property of the MTJ device due to a conductive etch byproduct produced during etching.

In accordance with an aspect of the present invention, there is provided a method for fabricating a magnetic tunnel junction. The method comprises forming a first magnetic layer, a dielectric layer, a second magnetic layer and a capping layer, selectively etching the capping layer and the second magnetic layer to form a first pattern, forming a short prevention layer on a sidewall of the first pattern, and etching the dielectric layer and the first magnetic layer using the capping layer and the short prevention layer as an etch barrier to form a second pattern.

### BRIEF DESCRIPTION OF THE DRAWINGS

FIG. 1 illustrates a cross-sectional view of a typical MTJ device on which an etch byproduct is deposited.

FIG. 2 illustrates a scanning electron micrograph of a typical MTJ device on which an etch byproduct is deposited.

FIGS. 3A to 3D illustrate a method for fabricating an MTJ device in accordance with an embodiment of the present invention.

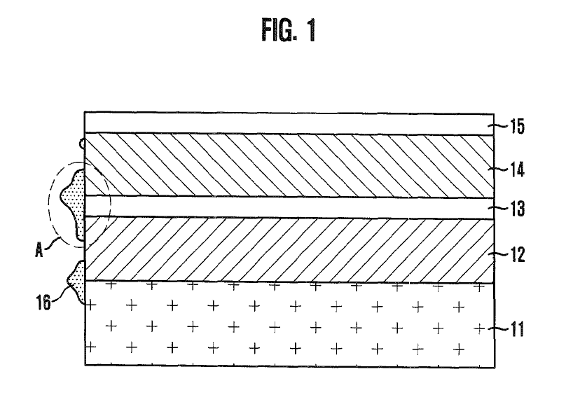

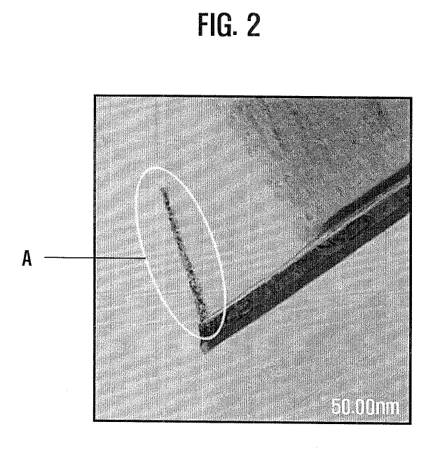

### DESCRIPTION OF SPECIFIC EMBODIMENTS

The embodiments of the present invention relate to a method that can prevent an electric short between a first ferromagnetic layer and a second ferromagnetic layer due to redeposition of a conductive etch byproduct produced during etching for fabricating an MTJ device.

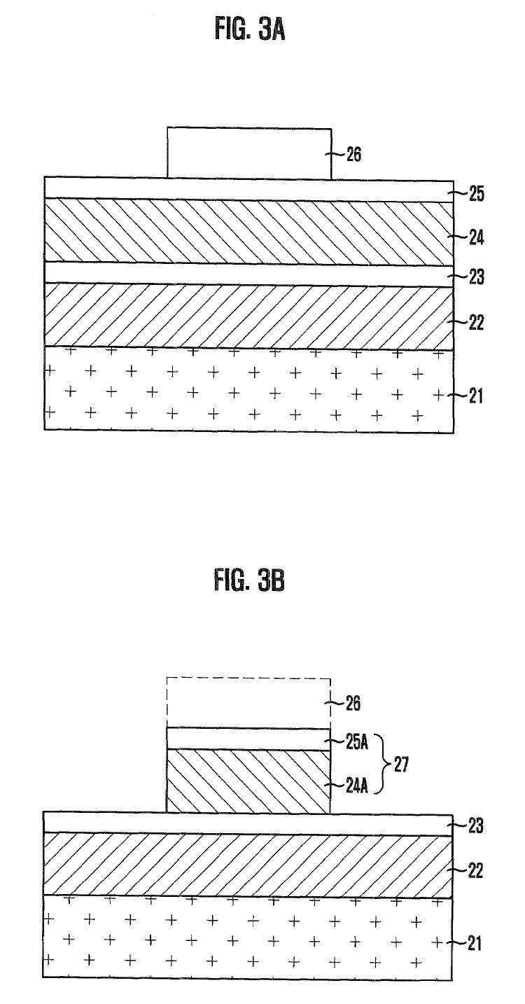

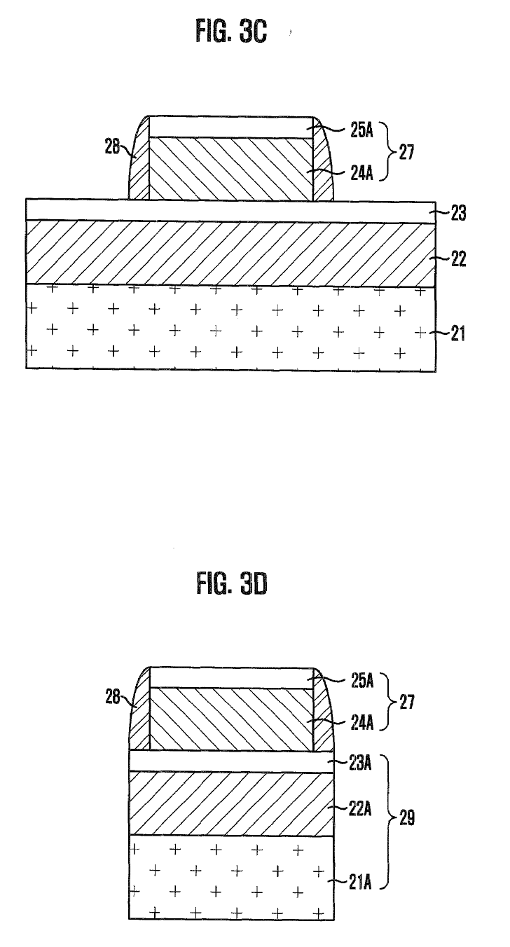

FIGS. 3A to 3D illustrate a method for fabricating an MTJ device in accordance with an embodiment of the present invention. Referring to FIG. 3A, an anti-ferromagnetic layer 21, a first ferromagnetic layer 22, a dielectric layer 23, a second ferromagnetic layer 24 and a capping layer 25 are sequentially formed.

The anti-ferromagnetic layer 21 is configured to fix a magnetization direction of the first ferromagnetic layer 22. The anti-ferromagnetic layer 21 may be formed of anti-ferromagnetic material, such as platinum manganese (PtMn) and iridium manganese (IrMn). Here, anti-ferromagnetic coupling formed between the anti-ferromagnetic layer 21 and the first ferromagnetic layer 22 can fix the magnetization direction of the first ferromagnetic layer 22.

The first ferromagnetic layer 22 and the second ferromagnetic layer 24 each may be a single layer formed of a ferromagnetic material, such as ferro-nickel (NiFe) and ferro-cobalt (CoFe). The first ferromagnetic layer 22 and the second ferromagnetic layer 24 each may also be multiple layers such as CoFe/Ru/CoFe where a ruthenium (Ru) is layered between ferro-cobalts (CoFe), and NiFe/Ru/NiFe where ruthenium (Ru) is layered between ferro-nickels (NiFe).

The dielectric layer 23 functions as a tunneling barrier between the first ferromagnetic layer 22 and the second ferromagnetic layer 24. The dielectric layer 23 may be formed of magnesium oxide (MgO) or aluminum oxide (Al₂O₃).

The capping layer 25 functions as a hard mask and also functions to prevent oxidation and corrosion of the second ferromagnetic layer 24 during the etching for fabricating the MTJ device. The capping layer 25 may be formed of a metal such as tantalum (Ta) or a metal compound such as tantalum nitride (TaN)

If a material constituting the second ferromagnetic layer 24 is oxidized or corroded due to an operational error, a magnetoresistance Rₘₛ of the MTJ device may be reduced. Accordingly, the capping layer 25 is formed to prevent this.

The magnetoresistance Rₘₛ is defined as percentage ratio of the resistance difference between the MTJ device in a high resistance state and that in a low resistance state to the resistance of the MTJ device in the low resistance state. As the magnetoresistance Rₘₛ is decreased, the resistance difference of the MTJ device between in the high resistance state and in the low resistance state may be reduced, thereby reducing the data storage characteristic of the MRAM device utilizing the MTJ device.

A hard mask pattern 26 is formed over the capping layer 25. The hard mask pattern 26 may be formed of a dielectric material such as silicon oxide (SiO₂) or a metal compound such as titanium nitride (TiN).

Referring to FIG. 3B, the capping layer 25 and the second ferromagnetic layer 24 may be etched using the hard mask pattern 26 as an etch barrier to form a first pattern 27.

That is, the capping layer 25 and the second ferromagnetic layer 24 are etched sequentially to form a capping pattern 25A a second ferromagnetic pattern 24A constituting the first pattern 27, respectively.

The hard mask pattern 26 may be removed completely during the forming of the first pattern 27. However, if a portion of the hard mask pattern 26 remains after the forming of the first pattern 27, an additional treatment may be performed to completely remove the hard mask pattern 26 before the subsequent process. Thereafter, a cleaning is performed to remove an etch byproduct produced during the forming of the first pattern 27.

Referring to FIG. 3C, a short prevention layer 28 is formed on a sidewall of the first pattern 27. The short prevention layer 28 is configured to prevent the conductive etch byproduct, which will be produced during the subsequent process for etching the first ferromagnetic layer 22 and the anti-ferromagnetic layer 21, from redepositing on the sidewall of the first pattern 27. That is, the short prevention layer 28 is configured to prevent an electric short between the second ferromagnetic pattern 24A and a first ferromagnetic pattern 22A due to the conductive etch byproduct. The short prevention layer 28 may be formed by forming a dielectric layer over the first pattern 27, and then performing an etch-back process on the dielectric layer.

The short prevention layer 28 may be a single layer selected from the group consisting of a carbon-containing layer, an oxide layer, a nitride layer and an oxynitride layer, or multiple layers thereof. The short prevention layer 28 may be formed to a thickness of approximately 50 Å to approximately 200 Å. The oxide layer may be formed of silicon oxide (SiO₂), boron phosphorus silicate glass (BPSG), phosphorus silicate glass (PSG), tetra ethyle ortho silicate (TEOS), un-doped silicate glass (USG), spin on glass (SOG), high density plasma (HDP) oxide, or spin on dielectric (SOD). The nitride layer may be formed of silicon nitride (Si₃N₄). The carbon-containing layer may be formed of amorphous carbon, spin on carbon (SOC), or silicon oxycarbide (SiOC).

Referring to FIG. 3D, the dielectric layer 23, the first ferromagnetic layer 22 and the anti-ferromagnetic layer 21 are sequentially etched using the capping pattern 25A and the short prevention layer 28 as an etch barrier to form a second pattern 29. That is, the dielectric layer 23, the first ferromagnetic layer 22 and the anti-ferromagnetic layer 21 are etched to form a dielectric pattern 23A, a first ferromagnetic pattern 22A and an anti-ferromagnetic pattern 21A constituting the second pattern 29, respectively.

Here, the etching of the first ferromagnetic layer 22 and the anti-ferromagnetic layer 21 of a metal compound produces a conductive etch byproduct. However, the short prevention layer 28 covering the sidewall of the second ferromagnetic pattern 24A can prevent an electric short between the first and second ferromagnetic patterns 22A and 24A due to the conductive etch byproduct. As such, it is possible to prevent deterioration of the electric property of the MTJ device due to the conductive etch byproduct, and thus to improve reliability and manufacturing yield of the semiconductor device utilizing the MTJ device.

In summary, by forming the short prevention layer on the sidewall of the second ferromagnetic layer, it is possible to prevent the electric short between the first and second ferromagnetic layers due to the conductive etch byproduct, and thereby to prevent the deterioration of the electric property of the MTJ device.

As such, it is possible to improve reliability and manufacturing yield of the semiconductor device utilizing the MTJ device.

While the present invention has been described with respect to the specific embodiments, it will be apparent to those skilled in the art that various changes and modifications may be made without departing from the spirit and scope of the invention as defined in the following claims.

What is claimed is:

1. A method for fabricating a magnetic tunnel junction device, the method comprising:
forming a first magnetic layer, a dielectric layer, a second magnetic layer and a capping layer;
selectively etching the capping layer and the second magnetic layer to form a first pattern;
forming a prevention layer on a sidewall of the first pattern; and
etching the dielectric layer and the first magnetic layer using the capping layer and the prevention layer as an etch barrier to form a second pattern.

2. The method of claim 1, wherein forming the prevention layer comprises:
forming a dielectric layer over the first pattern; and
performing etch back on the dielectric layer so that the prevention layer is formed on the sidewall of the first pattern.

3. The method of claim 1, wherein the prevention layer comprises a single layer.

4. The method of claim 1, wherein the prevention layer comprises a layer selected from the group consisting of an oxide layer, a nitride layer, an oxynitride layer and a carbon-containing layer, or multiple layers thereof.

5. The method of claim 4, wherein the carbon-containing layer comprises an amorphous carbon layer, a spin on carbon (SOC) layer or a silicon oxycarbide (SiOC) layer.

6. The method of claim 1, wherein the first magnetic layer comprises multiple layers of an anti-ferromagnetic layer and a ferromagnetic layer.

7. The method of claim 1, wherein the second magnetic layer comprises a ferromagnetic layer.
